(19) United States
(12) Patent Application Publication
(10) Pub. No.: US 2020/0177698 A1
(43) Pub. Date: Jun. 4, 2020

(54) METHOD AND SYSTEM FOR DETERMINING VALIDITY OF A USER ACCOUNT AND ASSESSING THE QUALITY OF RELATE ACCOUNTS

(71) Applicants: Leonid Zhavoronkov, Saint-Petersburg (RU); Kirill Kuznetsov, Saint-Petersburg (RU)

(72) Inventors: Leonid Zhavoronkov, Saint-Petersburg (RU); Kirill Kuznetsov, Saint-Petersburg (RU)

(21) Appl. No.: 16/207,158

(22) Filed: Dec. 2, 2018

(51) Int. Cl. H04L 29/08; G06Q 50/00; G06Q 30/02

(52) U.S. Cl. CPC H04L 67/306; G06Q 30/0201; H04L 67/22; G06Q 50/01

(57) ABSTRACT

A method comprising; analyzing a publisher account within a network, wherein the content is associated with and generated by the publisher account in the network, and the publisher account information comprises a set of engaged accounts, selecting a subset of engaged accounts associated with the publisher account within the network, wherein the subset of engaged accounts is associated with the publisher account through various activities within the network that are associated with the publisher account's generated content, processing each of the engaged accounts of the subset of accounts based on the engaged account's activity related to the content generated by the publisher account, wherein a determination is made related to the relevance of each of the engaged accounts of the subset of engaged accounts, calculating, by at least one processor, a score based on the number of relevant accounts of the set of engaged accounts of the network.

### BACKGROUND

This disclosure relates generally detection of objective user accounts, and more specifically to a method, computer program and computer system for determining if an account is fake or a bot account, and thereby accurately assessing the quality of the active audiences of the profile.

Over the past few years, online social networks have grown rapidly and an endless possibility for publicly expressing themselves, communicating with friends, and sharing information with people across the world.

Social networks allow users to communicate with one another for various personal and professional purposes through the sharing of content and ideas. These users are able to connect to one another to view each other's content either in the form of pictures, videos, or posts. In recent years, online social network such as Facebook, Twitter, Instagram, and Snapchat have been growing at exponential rates and serving hundreds of millions of users on a daily basis. The Facebook social network, for example, was founded in 2004 and had more than 1 billion users and Instagram has over 500 million daily users in 2017.

Due to this incredibly high volume of users, companies have taken to advertising their products through social media as well as compensating personalities to advertise for them on these to reach many more potential customers then previously possible. One of the more important metrics for these companies to determine the value of their advertising is how many users are reached by the advertisements or social media posts. Advertisers are concerned with reaching as many real people as possible.

One issue with this metric is the creation of bot or fake accounts. Hypothetically, every account created is associated with a living person, but due to the creation of many (some estimate that Instagram has over 95 million fake accounts) of these fake accounts the potential exposure of these advertisements can be greatly affected. These fake accounts do not provide any benefit to the advertiser and actually cost them profits.

These Fake accounts are relatively easy to set up, some social networking systems even permitting accounts which are not associated with real people. Many social networks not permit such account, they do not typically require users to prove their existence or have a sign-up process which can be easily manipulates by computer software to create these fake accounts.

Therefore, it is difficult for advertisers to determine the true reach of their advertisements. Besides targeting only real users, an advertising manager may wish to further narrow down the selection of relevant user accounts. For example, an advertising manager may be interested in user accounts of a specific gender or/and user age. Since many active audiences are populated with fake accounts and sometimes even entirely consist of fake accounts following a fake user. This behavior has a negative impact on the advertisers because they exhaust their budget on accounts with little to no impact on real potential customers.

Thus, it is important to have a process or system which can determine the true reach of an audience (e.g. an audience of a particular influencer). A process or system that is an easier and less resource intensive task and provides that advertisers with information that depicts an accurate representation of the real audience sizes.

### SUMMARY

In a first embodiment, the present invention is a computer-implemented method of determining the relevance of an audience comprising: analyzing, by at least one processor, a publisher account information and content within a networking service, wherein the content is associated with and generated by the publisher account in the networking service, and the publisher account information comprises a set of engaged accounts; selecting, by at least one processor, a subset of engaged accounts associated with the publisher account within the networking service, wherein the subset of engaged accounts is associated with the publisher account through various activities within the networking service that are associated with the publisher account's generated content; processing, by at least one processor, each of the engaged accounts of the subset of accounts based on the engaged account's activity related to the content generated by the publisher account, wherein a determination is made related to the relevance of each of the engaged accounts of the subset of engaged accounts; calculating, by at least one processor, a score based on the number of relevant accounts of the set of engaged accounts of the networking service; and publicizing, by at least one processor, the score to identify the profile account trustworthy following within the networking service.

In a second embodiment, the present invention is a computer program product for of determining the relevance of an audience, the computer program product comprising: one or more computer readable storage media and program instructions stored on the one or more computer readable storage media, the program instructions comprising: program instructions to analyze a publisher account information and content within a networking service, wherein the content is associated with and generated by the publisher account in the networking service, and the publisher account information comprises a set of engaged accounts; program instructions to select a subset of engaged accounts associated with the publisher account within the networking service, wherein the subset of engaged accounts is associated with the publisher account through various activities within the networking service that are associated with the publisher account's generated content; program instructions to process each of the engaged accounts of the subset of accounts based on the engaged account's activity related to the content generated by the publisher account, wherein a determination is made related to the relevance of each of the engaged accounts of the subset of engaged accounts; and program instructions to calculate, a score based on the number of relevant accounts of the set of engaged accounts of the networking service.

In a third embodiment, the present invention is a computer system for of determining the relevance of an audience, the computer program product comprising: one or more computer processors, one or more computer readable storage media, and program instructions stored on the one or more computer readable storage media for execution by, at least one of the one or more processors, the program instructions comprising: program instructions to analyze a publisher account information and content within a networking service, wherein the content is associated with and generated by the publisher account in the networking service, and the publisher account information comprises a set of engaged accounts; program instructions to select a subset of engaged accounts associated with the publisher account within the networking service, wherein the subset of engaged accounts is associated with the publisher account through various activities within the networking service that are associated with the publisher account's generated content; program instructions to process each of the engaged accounts of the subset of accounts based on the engaged account's activity related to the content generated by the publisher account, wherein a determination is made related to the relevance of each of the engaged accounts of the subset of engaged accounts; and program instructions to calculate, a score based on the number of relevant accounts of the set of engaged accounts of the networking service.

### BRIEF DESCRIPTION OF THE DRAWINGS

FIG. 1 depicts a block diagram depicting a computing environment, in accordance with one embodiment of the present invention.

FIG. 2 depicts a block diagram of the relationship between a publisher account and an activate audience of that publisher account, in accordance with one embodiment of the present invention.

FIG. 3 depicts a block diagram of the active audience and the publisher accounts content, in accordance with one embodiment of the present invention.

FIG. 4 depicts a block diagram of the types of accounts comprising the active audience, in accordance with one embodiment of the present invention.

FIG. 5 depicts a flowchart of the operational steps taken to train a detection program to detect relevant and irrelevant users, in accordance with an embodiment of the present invention.

FIG. 6 depicts a flowchart of the operational steps taken by the detection program to determine the true reach of a publisher account, according to an embodiment of the present disclosure.

FIG. 7 depicts a block diagram depicting the internal and external components of a computing device or a server of FIG. 1, in accordance with one embodiment of the present invention.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

People (or the active audience) use social networking for various purposes. Social networking systems (or services) can utilize on people's computing devices (or systems) to establish connections, communicate, and interact with one another via these social networking services. People can also provide, create, edit, share, or access content such as images, videos, audio, articles, links, and text. In many social networking services, a user may have many other users who follow, are linked with, or connected to their account, these users are sometimes referred to as active audiences (hereinafter users whom follow the profile are referred to as active audiences).

Some businesses use social networking services to promote their products and advertise through various account profiles. These people are sometimes referred to as influencers. An influencer typically is a celebrity, musician, actor, or personality that has many (thousands if not millions of active audiences). These influencers influence their active audiences to purchase goods and/or services. Due to the large following of these influencers, business see it as a successful means to promote their products or services to large groups of people with minimal efforts.

However, as the size of social networking services has grown, and many people learning that they can generate income through these businesses by promoting their products/services, some people have begun to embellish their following by having a number of fake or bot accounts, thereby giving the impression of popularity. This results in a business investing in these embellished “users” and seeing very little return on their investment.

An improved approach to identifying legitimate accounts and an accurate representation of their true following overcomes the disadvantages associated with conventional approaches. In general, systems, methods, and computer readable media of the present disclosure can identify an account's following and generated content to determine if the following is accurate and legitimate. A machine learning algorithm can develop a machine learning model for determining the probability that an account's following is legitimate and identify an account that have falsified their following with bot or fake accounts. In some instances, a plurality of models can be developed to better analyze the various accounts. Each model can be trained using determinations resulting from manual review by administrators associated with the social networking system regarding whether the generated content or active audiences are legitimate or fake.

Embodiments of the present invention discloses the use of a detection algorithm that takes a first account and separates the “users” associated with the first account into relevant (real people) and irrelevant (bot, fake, or non-human) accounts. Once the separation has occurred the first account is scored, and the analysis is used to further train the detection algorithm.

The present invention proposes a process for the detection of fake or bot accounts in social networking services, based on the account information and the account's generated (and in some cases lack of generated) content.

The present invention will now be described in detail with reference to the Figures.

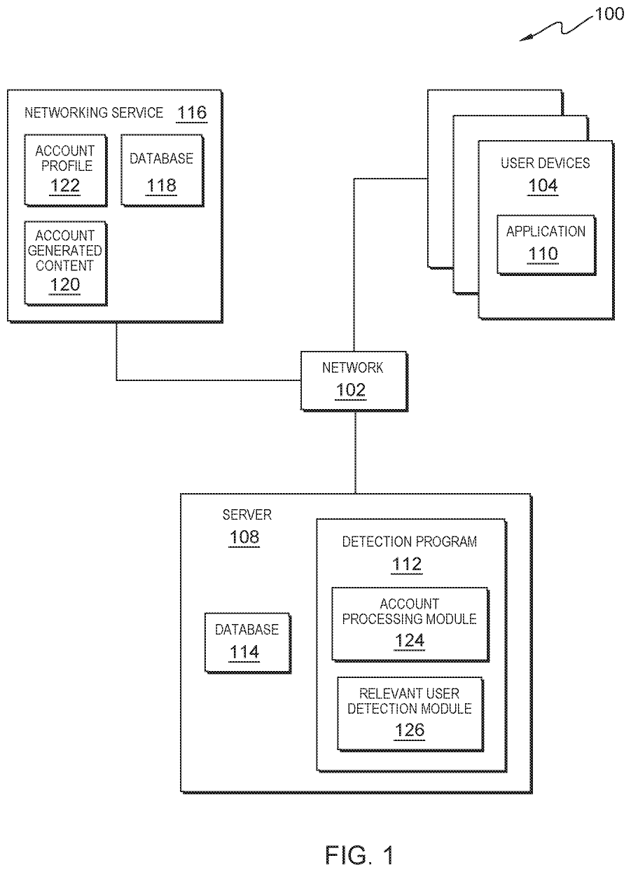

FIG. 1 depicts a block diagram of a computing environment 100 in accordance with one embodiment of the present invention. FIG. 1 provides an illustration of one embodiment and does not imply any limitations regarding the environment in which different embodiments maybe implemented. In the depicted embodiment, computing environment 100 includes network 102, one or more user devices 104, networking service 116, and one or more server 108. Computing environment 100 may include additional servers, computers, or other devices not shown.

In one embodiment, the networking service 116 may be operated by a network provider, whereas the server 108 and the user devices 104 are separate from the networking service 116 and operate independently.

Network 102 may be a local area network (LAN), a wide area network (WAN) such as the Internet, any combination thereof, or any combination of connections and protocols that can support communications between networking service 116, the user devices 104, and server 108 in accordance with embodiments of the invention. Network 102 may include wired, wireless, or fiber optic connections. The network 102 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 102 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 102 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

User device(s) 104 comprise one or more computing devices which can receive input from a user and transmit and receive data via network 102. The user devices 104 may be any other electronic device or computing system capable of processing program instructions and receiving and sending data. In one embodiment, the user devices 104 is a conventional computer system executing, for example, a Microsoft Windows compatible operating system (OS), Apple OS X, and/or a Linux distribution. In another embodiment, the user devices 104 can be a device having computer functionality, such as a smart-phone, a tablet, a personal digital assistant (PDA), a mobile telephone, etc.In some embodiments, user devices 104 may be a laptop computer, tablet computer, netbook computer, personal computer (PC), a desktop computer, or any programmable electronic device capable of communicating with networking service 116 and server 108 via network 102. In other embodiments, user devices 104 may represent a server computing system utilizing multiple computers as a server system, such as in a cloud computing environment. In another embodiment, user devices 104 represents a computing system utilizing clustered computers and components to act as a single pool of seamless resources.

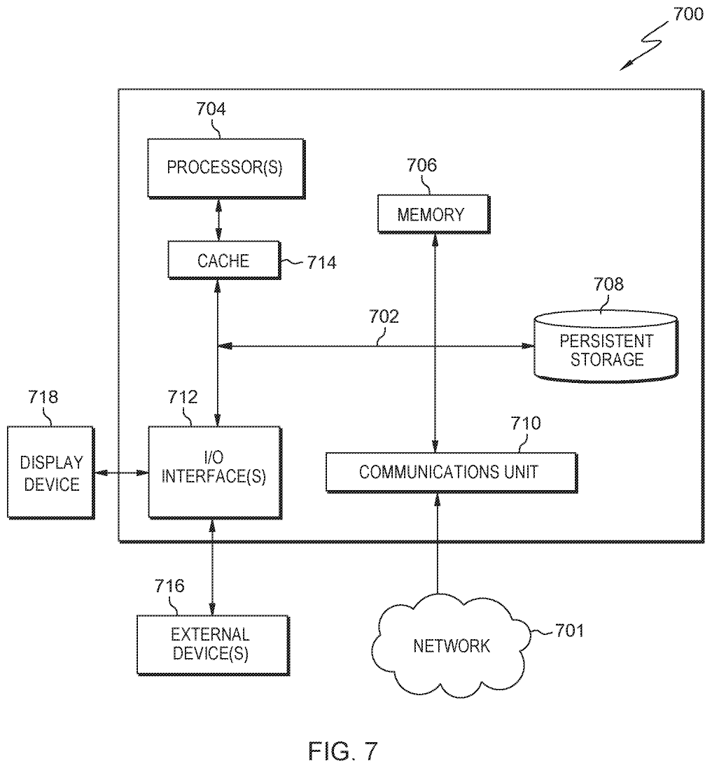

In one embodiment, the user devices 104 interact with the networking service 116 through an application programming interface or application 110, such as iOS and ANDROID. The user device 104 may display content through the processing of markup language and displaying this information through the application 110. The application 110 displays the identified content using the format or presentation described by the markup language. Examples of the markup language are extensible markup language (XML) data, extensible hypertext markup language (XHTML) data, or other markup language data. The application 110 may also include the ability to process JavaScript Object Notation (JSON) data, JSON with padding (JSONP), and JavaScript data to facilitate data-interchange between the networking service 116 and the user device 104 and the user device 104 and the server 108. In other embodiments, user devices 104 may include any combination of detection program 112, database 114. User devices 104 may include components, as depicted and described in further detail with respect to FIG. 7.

Networking service 116 includes one or more computing devices for a social network, including a plurality of account profiles 122, and providing users of the social network with the ability to communicate and interact with other users of the social network. Examples of these social networks are Twitter®, Youtube® Facebook®, Instagram®, and the like. These social networks allow for users to connect and communicate with one another, in some instances, the networks may be represented by edges and nodes which are connected to one another. Other data structures can also be used to represent the networking service 116, including but not limited to databases, objects, classes, meta elements, files, or any other data structure. Users may join the social networking service 116 and then add connections to any number of other users of the social networking service 116. Connections may be added explicitly by a user or may be automatically created by the social networking service 116 based on common characteristics of the users. Connections in the social networking service 116 are usually in both directions but need not be. This network may vary from one social media network to next wherein web servers, API requests, external systems, authorization, security systems, privacy systems, logging systems, and the like may be incorporated.

account profile 122 are the accounts associated with the networking service 116. These accounts are presumed to be associated with a real entity (e.g. person, place, thing, company, organization, etc.) and not controlled by a computer (e.g. a bot). The account profile 122 maintain information about each account profiles 112, including biographic, demographic, and other types of descriptive information to identity the user. Each of the account profile 122 are stored (internally or externally by each of the networking service 116) and are uniquely identified. These account profile 122 may be stored located on various servers, computing devices, cloud computing systems, and other storage mediums. As various networking services 106 store their data in different manners, and with varying degrees of access to the public based on social network security features and account privacy settings. In the depicted embodiment, these account profile 122 are located on the networking service 116 in a database 114. In additional embodiments, the account profile 122 may be stored in a plurality of locations and storage devices.

Account generated content 120 includes all information generated by or published by a specific account profile 122. The account generated content 120 enhances an account's interactions with the networking service 116. The account generated content 120 may include anything an account can add, upload, send, or “post” to the networking service 116. Posts may include data such as status updates or other textual data, location information, images such as photos, videos, links, music or other similar data and/or media. The account generated content 120 includes both account generated content as well as third party or other account generated content which is associated with the account generated content 120. This associated content 120 is linked or connected with the account profile 122. This association may be in the form of commenting on other account profile 122 content, “like” other account account's generated content, tagging another account profile 122 in a comment, or reacting to content based on the design and structure of the networking service 116 and how it intends its users to interact. In this way, users of the networking service 116 are encouraged to communicate with each other by posting text and content items of various types of media through various communication channels. Such communication increases the interaction of users with each other and increases the frequency with which users interact with the networking service 116. In the main embodiment, the account generated content 120 is content visible to the public. In some embodiments, private or non-public content is incorporated into the account generated content 120. In additional to the account generated content 120 is stored by the networking service 116, which is uniquely identified with the specific account profile 122.

Database 114 may be a repository that may be written to and/or read by networking service 116 various components. Account profile 122 and account generated content 120 as well as other data associated with each account profile 122 may be stored in database 114. Such information may include account information, account activity, account relationships, and other account features. In one embodiment, database 114 is a database management system (DBMS) used to allow the definition, creation, querying, update, and administration of a database(s). In the depicted embodiment, database 114 resides within networking service 116. In other embodiments, database 114 resides on another server, or another computing device, provided that database 114 is accessible by the networking service 116 and its components.

Server 108 may be a management server, a web server, or any other electronic device or computing system capable of processing program instructions and receiving and sending data. In another embodiments server 108 may be a laptop computer, tablet computer, netbook computer, personal computer (PC), a desktop computer, or any programmable electronic device capable of communicating via network 102. In one embodiment, server 108 may be a server computing system utilizing multiple computers as a server system, such as in a cloud computing environment. In one embodiment, server 108 represents a computing system utilizing clustered computers and components to act as a single pool of seamless resources. In the depicted embodiment detection program 112 is located on server 108. Server 108 may include components, as depicted and described in further detail with respect to FIG. 7.

Detection Program 112 functions to access the information from the networking service 116 associated with account profile 122, the account generated content 120, and the like and determine the validity of the account profile(s) 122 and provide an assessment of the analyzed accounts. The detection program 112 selects an account profile 122 and analyzes the account profile(s) 122 linked or associated with this selected account profile 122 to determine the quantity of relevant account profiles (associated with a real entity) or irrelevant account profiles (associated with a bot or a fake profile) which are associated with the selected account profile 122. Once the detection program 112 separates the audiences into either category, an analysis is performed on the profile to generate a plurality of values associated with the profile to assess the authenticity of the audiences and provide extracted features that can be used to detect irrelevant accounts in future iterations of the location process. In the depicted embodiment, detection program 112 has a plurality of modules to perform specific functions of the programs design. Various modules may be included to complete these functions. In the depicted embodiment, detection program 112 resides on server 108 and utilizes network 102 to access networking service 116 and user device 104. In one embodiment, detection program 112 resides on a separate server 108. In other embodiments, detection program 112 may be located on another server, computing device, or exist in a cloud computing system provided detection program 112 has access to networking service 116 and user devices 104.

The detection program 112, in some embodiments, may have one or more servers that include one or more web pages, which are communicated to the user device 104 using the network 102. The server 108 is separate from the networking service 116 and their web pages provide the markup language documents created by the detection program 112, which identify the content to the user device 104 if no application which can process the content is present on the user device 104.

Database 118 may be a repository that may be written to and/or read by detection program 112. Information associated with the information or data generated by detection program 112 may be stored to database 118. Such information may include account profile 122 information, account activity, account relationships, and other account features. In one embodiment, database 118 is a database management system (DBMS) used to allow the definition, creation, querying, update, and administration of a database(s). In the depicted embodiment, database 118 resides on server 108. In other embodiments, database 118 resides on another server, or another computing device, provided that database 118 is accessible to detection program 112.

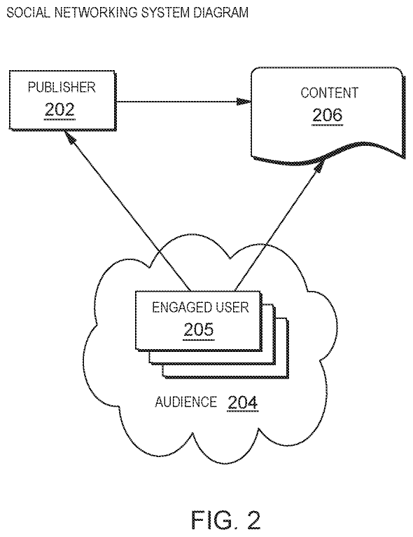

FIG. 2 depicts the relationship between a publisher account 202 and the audience 204 within the networking service 116 diagram in accordance with one embodiment of the present invention. This diagram 200 represents the communication between the publisher account 202, the audience 204, and the content 206. The publisher account 202 generates content 206. The content 206, as stated above, is any account generated content 206 within the networking service 116. This may include, but not limited to post images, videos, text, links, comments, or the like. The audience 204 is all the accounts who have access to see the content 206. The audience 204 has a group of engaged users 205 who interact with the content 206 generated by the publisher account 202. In many networking services, the content 206 generated by the publisher account 202 is public for all users to see. Of those users, there is an engaged user 205 which interacts with either the publisher account 202 (e.g. by following or becoming connecting “friends”) or interacts with the content 206 (e.g. liking, commenting, reposting, etc.). For example, on Facebook® an engaged user 205 is another user that has commented or: liked” content 206 posted by the publisher account 202. Another example is with Instagram® a publisher account 202 posts a picture 206 and their engaged users 205 liked the post or repost the post on their own account. In some embodiments, the audience 204 is a group of one or more engaged users 205 which regularly receive content 206 published by the publisher account 202. Detection program 112 generates an assessment of the publisher account 202 based on the engaged users 205 of the audience 204.

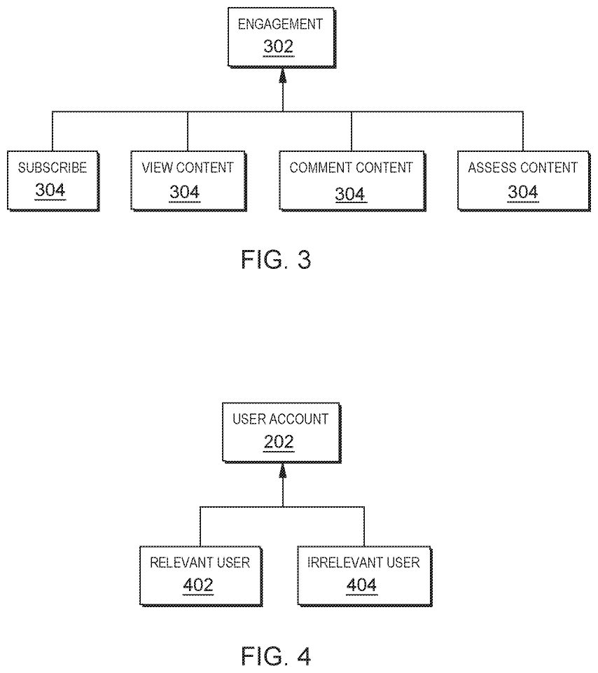

FIG. 3, depicts an engagement diagram 300 between the publisher account 202 and the engaged users 205. The engagement 302 is any type of interactions 304 the engaged users 205 may have with the publisher account 202. In the depicted embodiment, the engagement 302 is any type of interaction, including, but not limited to, subscribing to the publisher account 202, viewing content of the publisher account 202, commenting on the content generated by the publisher account 202, assessing content 206 generated by the publisher account 202, or the like based on the social networking service 116. These examples of types of engagement 302 are only an example, as the vast number of networking services 116 each have specific and specialized types of engagement 302. The verbiage used to describe the engagement 302 is only for exemplary purposes, as many networking services 116 have specific language and lexicography associated with their services, and the verbiage in this application is not intended to limit the engagement types.

FIG. 4 depicts block diagrams 400 of the type of engaged users 205 which are interacting with the publisher account 202, in accordance with one embodiment of the present invention. Prior to the assessment of the publisher account 202 by the detection program 112, both relevant 402 and irrelevant 404 users are able to engage with the publisher account 202. It is typically unknown, if an engaged user 205 is a relevant user 402 or an irrelevant user 402. In many situations where a publisher account 202 has thousands or millions of engaged users 205, it is impossible to effectively delineate one from the other. With many publisher accounts 202 posting content 206 many times a day, it is difficult to keep up with the most current content 206 and the engaged user 205 types. Where the problem lies for business spending capital to invest in these publisher accounts 202 is the relevant users 402 are actual users and are actually able to purchase goods that which the publisher account 202 is promoting and produce income for the business. The non-existing accounts (e.g. bot, fake, phishing, etc.) 404cannot purchase the goods or services offered by the business. Therefore, it is valuable to understand the true following of a publisher account 202 prior to investing in them.

The relevant users 402 are closely associated with real people. These are the accounts that are controlled and run by a real person. The person is either the actual name and user of the account or a manager of an account if it is associated with an entity (e.g. business, corporation, organization, group, or the like).

The irrelevant accounts 404 are like associated with social bots, fake profiles, phishing attacks, spammers, and all other type of non-existent person accounts whose purpose is to merely bolster or falsify the popularity of a publisher account 202. In some instances, there are special services which users can subscribe to which automatically follow certain accounts, and comment on the user's behalf to increase the activity on their account. Specific social networks where a publisher account 202 has engaged users 205 of the may directly relate to the popularity of the account or be used to attract various advertising agencies or companies for a monetary gain. The negative effect of the agencies or companies sponsoring or investing in publisher account 202 with a majority of irrelevant accounts 404 and 404B associated with it, is the lack of exposure.

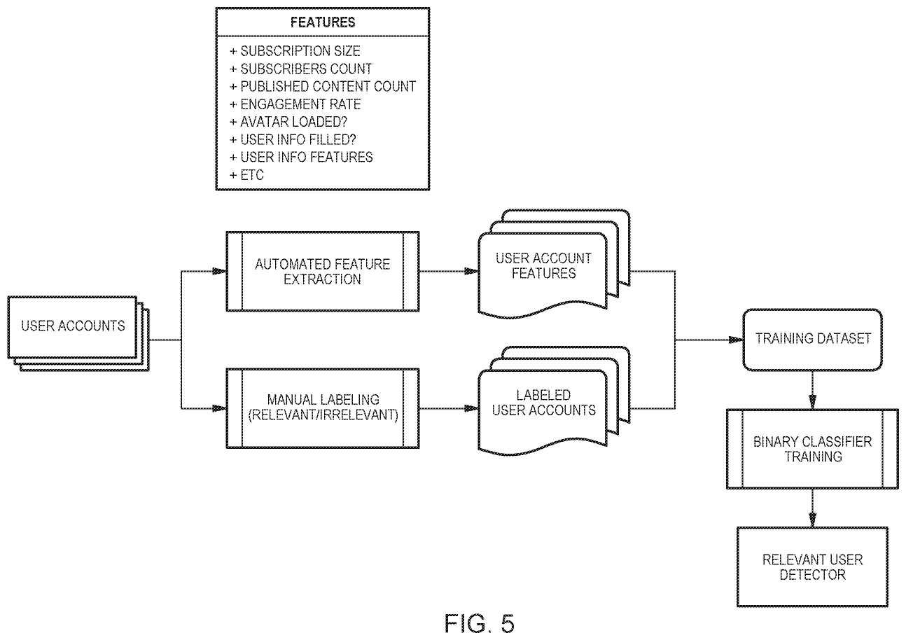

FIG. 5 shows flowchart 500 depicting the operational steps taken to train the detection program 112 to detect the relevant accounts 402 from the irrelevant accounts 404, according to an embodiment of the present disclosure. It should be appreciated that there can be additional, fewer, or alternative steps performed in similar or alternative orders, or in parallel, in accordance with the various embodiments discussed herein unless otherwise stated. The method(s) and associated process(es) are now discussed, over the course of the following paragraphs, with extensive reference to FIG. 5, in accordance with one embodiment of the present invention. The purpose of the process(s) performed are to determine the construction of the relevant user detection module 126. The relevant user detection module 126 is used to train the program to more accurately and correctly identify relevant users 402 and irrelevant users 404.

The relevant user detection module 126, selects a publisher account 202. Of the publisher account 202, a subset of the engaged users 205 are selected. For this subset, both the relevant user detection module 126 and a manual or machine learning process, process each engaged user 205 of the subset. The processed engaged users 205 are analyzed for account information, account features, generated content, and engagements 302 with the publisher account 202. The engaged user 205 account information and content may be varied depending on the networking service. For exemplary purposes the engaged user 205 account information may include, but not limited to, user name, user avatar, user biographical information, number of users following the account, number of users the account is following, and the content may be, but not limited to, generated posts (time, date, location, video, text, or images, hashtags, etc.), comments on posts (e.g. time, date, content, etc.) either generated by the profile or generated by other users, and the like. All of this information is analyzed and processed.

When analyzing the engaged users 205, the engagement 302 is scrutinized to assist in determining the relevance of the account. The engaged user 205 account's username, avatar, and/or identification name is collected as well as other data associated with the account, e.g. location, age, sex, and other data provided with the engaged users 205. The subscription size, subscribers count, and the like are collected. The age may be associated with the date the engaged user 205 account was created as well as the age of the “user”. Each action of the engaged user 205 account associated with the profile is analyzes. This is related to the time of engagement (e.g. from time profile publishes the content), the content of the comment. In some embodiments natural language analysis is performed on the comment to determine if words, slang, emojis, or the like are used and the apparent meaning of the comment. The association of the comment to the published content. The engaged user 205 account may also be analyzed for an amount of content published by the engaged user 205, which is associated with the publisher account 202 and other accounts, number of associated accounts, engagement rate of the engaged user account. The analysis of the subset of engaged user 205 accounts may happen in succession or simultaneously.

Additionally, the publisher account 202 is analyzed to determine the history of the account. This may include, but not limited to the number of the audience 204 over time, or over a predetermined range of time. This assists in detecting if there are any major fluctuations in the audience of the publisher account 202. The relevant user detection module 126, analyzes the adjustment (either increase or decrease) of the audience over a predetermined time period to determine if the fluctuation of the audience 204 is realistic or likely the result of irrelevant accounts 404 being added to the audience. For example, if the growth of the audience 204 is steady over time, versus if there is a large spikes or adjustment of the audience 204 in a short time period. Similar to above, the relevant user detection module 126 uses machine learning technology or manual assistance to determine patterns associated with realistic fluctuations in the audience, and fluctuations which are deceptive or unrealistic and likely related to the audience being altered by irrelevant accounts 404. In some embodiments, real world events may result in large spikes and fluctuations in an audience 204, for example such as sports team winning a championship, or an actress winning an award. These are considered based on the machine learning technology and/or manual review of the relevant user detection module 126 findings.

The engaged users 205 are analyzed related to the engagement 302 with the publisher account's content 206. The engaged users 205 are analyzed to determine the relevance to the content 206 (e.g. is it a randomly generated term or associated with the subject matter of the content). The speed at which the engaged user 205 engages the content 206 (e.g. is it within a few seconds, milliseconds, hours, days, etc.). The engaged user 205 is also analyzed to determine if the engagement 302 is identical or similar to engagement 302 with other content 206. This is beneficial because if the engaged user 205 is engaging with a plurality of publisher accounts with identical engagements, it is likely to be an irrelevant account 404.

The engaged users 205 are analyzed in relation to the publisher account 202 as well as other accounts associated with the engaged user 205. This assists the relevant user detection module 126 to better understand the engaged user's 205 actions with regards to all publishing accounts. For example, if an engaged user 205 is posting the exact same comment, on a number of profiles at nearly identical times, this factor leads to the assessment, that a real person is unable to perform that action.

Either manually or through at least one other machine learning model trained on relevant 402 and irrelevant 404 accounts, each engaged user 205 account of the subset is determined to be relevant or irrelevant. The identified information associated with each of the engaged user 205 accounts is stored to provide a dataset to delineate the relevant from the irrelevant engaged users 205.

This collected data is used to generate a training dataset for at least one machine learning model. The generated training dataset is used to develop a machine learning model to determine independently if an account is relevant or irrelevant based on the account information and the account content. In some instances, a plurality of machine learning models can be developed to more optimally determine such relevance. Each machine learning model can be trained and retrained using the previously discussed process. The manual review can be performed by one or more employees or staff.

In some embodiments, the binary classifier training is performed by a set of personnel, who create a baseline of relevant and irrelevant accounts. In some embodiments, this initial set of accounts is at least five thousand (5,000). This baseline is then used to train the relevant user detection module 126 and other machine learning models which are then capable of classifying accounts. In some instances, there is an admissible error rate or tolerance to this

In an evaluation phase, when irrelevant (or relevant) engaged user 205 accounts are identified, the content generated by the engaged user 205 accounts can be applied to the machine learning model to further improve the model's ability to distinguish between relevant 402 and irrelevant 404 account profiles. In some embodiments, when an account is identified as irrelevant, all content generated by that account is grouped as irrelevant.

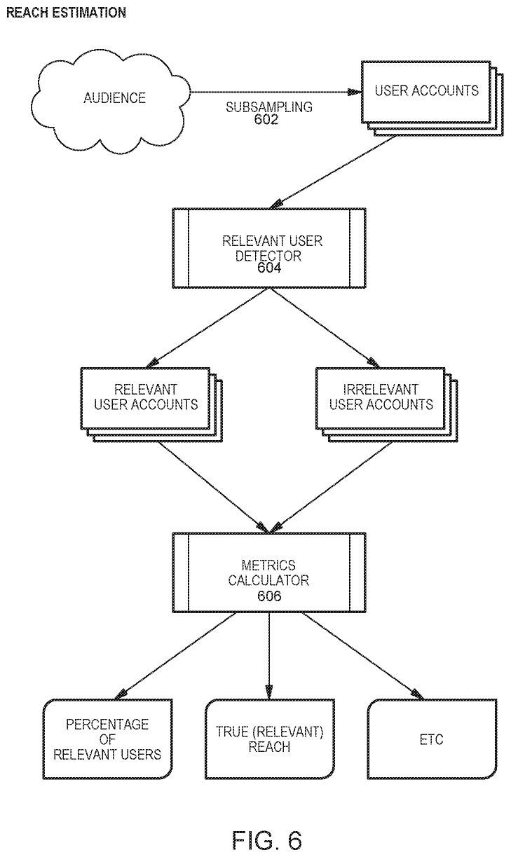

FIG. 6 illustrates an example first method to determine the true reach of a publisher account 202, according to an embodiment of the present disclosure. Each publishing account 205 has an apparent reach (e.g. the audience 204) and a true reach (e.g. the number of engaged users 205 which are relevant accounts 402) It should be appreciated that there can be additional, fewer, or alternative steps performed in similar or alternative orders, or in parallel, in accordance with the various embodiments discussed herein unless otherwise stated.

The apparent reach may be deceiving as some of the engaged users 205 may be irrelevant accounts. Hence the need for the calculation of the true reach, to show the portion of the engaged users 205 which are relevant accounts. The true reach is what is desired by many to determine the value of the profile for various reasons.

In some embodiments, one or all of the steps performed by reach module 124 may be generated automatically by an adaptable algorithm that dynamically changes based on, but not limited to, previously monitored behavior of the module or user activity. The functions or processes may be a form of, but not limited to, artificial intelligence, neural network, deep learning, reinforcement learning, Bayesian learning, or a combination thereof. These types of learning algorithms may be implemented to allow the system to run autonomously and analyze a multiple of accounts in succession. For example, once the publisher account 202 is analyzed, all engaged user 205 accounts associated with the publisher's account 202 are then analyzed and so on.

A publisher account 202 is selected either manually or automatically to be assessed. The reach module 124 may select the publisher account 202 which has been flagged or is of interest once a set of criteria have been met. These criteria may include the number of the audience 204 reaching a set minimum or the like. The publisher account 202 may be flagged by other users, staff and employees of the networking service 116, or a third party.

The publisher account's 202 account information and content 206 are analyzed within a predetermined time period to set the timeframe in which the audience 204 is determined to be associated with the publisher's account 202 pursuant to FIG. 3. The publisher account's 202 account information and content 206 are analyzed within a predetermined time period to determine if the account is relevant or irrelevant. If the account is determined to be irrelevant, the account is flagged and processed as an irrelevant account and the reach module 124 terminates the process and provides the staff of the finding. If the publisher account 202 is determined to be relevant, the reach module 124 accesses a subset of the engaged users 205 the publisher account 202.

In some embodiments, the content 206 is analyzed to determine the type of content generated by the publisher account 202. For example, if a picture is published the image is analyzed for subject matter. Written publications are analyzed for meaning through various natural language programs. Audio and video files are analyzed for subject matter.

The subset or sampling size of engaged users 205 is selected to be analyzed. The quantity and diversity of the subset and sampling is determined by the reach module 124 or by manual selection of a third party. In some embodiments, a predetermined set of factors dictate the subset size and which of the engaged users 205 are selected. For example, some factors may be, but not limited to, a predetermined time frame, wherein the engaged users 205 in that window are part of the sampling, the age of the relationship between the publisher account 202 and the engaged users 205, alphabetical, or previous knowledge of the type of account the engaged users 205 is. If the follow has been analyzed with a prior analysis, the reach module 124 may choose to exclude them from the selection but use them in the calculation in the later steps.

The subset of engaged users 205 is then analyzed by the relevant user detection module as described above in FIG. 5. The module analyzes each of the engaged users 205 for the account features, the account actions, and additional information specific to the networking service or which assists the reach module 124. The result of this analysis is provided to the reach module 124 for calculation purposes. Each account publisher account 202 of the subset is then determined to be either a relevant account or an irrelevant account. In some instances where an account is within a certain tolerance or score, the account is flagged for manual review. In some instances, an engaged user 205 may not be able to be determined to be relevant or irrelevant and another engaged user 205 may be selected for review to keep the previous sample size, or the calculation is performed with the new sample size.

With the analysis of the account publisher account 202 and the categorization of the subset into relevant and irrelevant engaged users 205 completed. The reach module 124 calculates a reach score associated with the account publisher account 202 to determine the audience quality score. This audience quality score is the overall score of the account publisher account 202 based on various means of which the subset is broken down into.

For example, the audience quality score can be calculated from a plurality of other calculated scores based on various characteristics of each networking service. For example, the audience quality score may be comprised of, but not limited to, relevant engaged users 205 among likers and commenters, relevant profiles among engaged users 205, engaged users 205 relative to total engaged users 205, comments of engaged users 205 relative to total number of engaged users 205, quality of comments, and the like. The relevant profiles among likers and commenters is the number of engaged users 205 which are relevant vs. irrelevant which have commented or engaged with the publisher account 202. The relevant profiles among the engaged users 205 is the number of engaged users 205s who are relevant vs. irrelevant. The engaged users 205s relative to total engaged users 205s, compares the number of engaged users which are relevant to the total number of engaged users 205s of the publisher account 202. The number of comments of engaged users 205s relative to total number of engaged users 205s, compares the actual comment which was analyzed to the total number of engaged users 205s. The quality of the comments is analyzed to determine even if the account is relevant, the comment may be unrelated to the post. These calculations are based upon the networking service types as each service may have drastically different designs and methods of user engagement and require modification from one service to the next.

In additional embodiments, networking service averages may be incorporated into the calculation, such that it may be common for accounts to have an average number of irrelevant accounts (e.g. 30%) and these modifiers or baseline values are incorporated into the calculation to keep the values consistent.

FIG. 7 depicts a block diagram 700 of components of a computing device (e.g. networking service 104, user device 104, and/or server 108), in accordance with an illustrative embodiment of the present invention. It should be appreciated that FIG. 1 provides only an illustration of one implementation and does not imply any limitations with regard to the environments in which different embodiments may be implemented. Many modifications to the depicted environment may be made. It should be appreciated FIG. 1 provides only an illustration of one implementation and does not imply any limitations with regard to the environments in which different embodiments may be implemented.

Computing environment 700 is, in many respects, representative of the various computer subsystem(s) in the present invention. Accordingly, several portions of computing environment 700 will now be discussed in the following paragraphs.

Computing device 700 includes communications fabric 702, which provides communications between computer processor(s) 704, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any additional hardware components within a system. For example, communications fabric 702 can be implemented with one or more buses.

Computing device 700 is capable of communicating with other computer subsystems via network 701. Network 701 can be, for example, a local area network (LAN), a wide area network (WAN) such as the Internet, or a combination of the two, and can include wired, wireless, or fiber optic connections. In general, network 701 can be any combination of connections and protocols that will support communications between computing device 700 and other computing devices.

Memory 706 and persistent storage 708 are computer-readable storage media. In one embodiment, memory 706 includes random access memory (RAM) and cache memory 714. In general, memory 706 can include any suitable volatile or non-volatile computer-readable storage media.

Memory 706 is stored for execution by one or more of the respective computer processors 704 of computing device 700 via one or more memories of memory 706 of computing device 700. In the depicted embodiment, persistent storage 708 includes a magnetic hard disk drive. Alternatively, or in addition to a magnetic hard disk drive, persistent storage 708 can include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer-readable storage medium that is also part of persistent storage 708.

Communications unit 710, in the examples, provides for communications with other data processing systems or devices, including computing device 700. In the examples, communications unit 710 includes one or more network interface cards. Communications unit 710 may provide communications through the use of either or both physical and wireless communications links.

I/O interface(s) 712 allows for input and output of data with other devices that may be connected to computing device 700. For example, I/O interface 712 may provide a connection to external devices 716 such as a keyboard, keypad, camera, a touch screen, and/or some other suitable input device. External devices 716 can also include portable computer-readable storage media such as, for example, thumb drives, portable optical or magnetic disks, and memory cards. Software and data used to practice embodiments of the present invention, e.g., regulation program 420 can be stored on such portable computer-readable storage media and can be loaded onto persistent storage 708 of computing device 700 via I/O interface(s) 712 of computing device 700. Software and data used to practice embodiments of the present invention, e.g., regulation program 420 can be stored on such portable computer-readable storage media and can be loaded onto persistent storage 708 of computing device 700 via I/O interface(s) 712 of computing device 700. I/O interface(s) 712 also connect to a display 718.

Display 718 provides a mechanism to display data to a patient and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the patient's computer, partly on the patient's computer, as a stand-alone software package, partly on the patient's computer and partly on a remote computer or entirely on the remote computer or server. In the latter scenario, the remote computer may be connected to the patient's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

What is claimed is:

1. A computer-implemented method of determining the relevance of an audience comprising:
analyzing, by at least one processor, a publisher account information and content within a networking service, wherein the content is associated with and generated by the publisher account in the networking service, and an audience associated with the publisher account, wherein the audience is comprised of a set of engaged accounts;
selecting, by at least one processor, a subset of engaged accounts associated with the publisher account within the networking service, wherein the subset of engaged accounts is associated with the publisher account through various activities within the networking service that are associated with the publisher account's generated content;
processing, by at least one processor, each of the engaged accounts of the subset of accounts based on the engaged account's activity related to the content generated by the publisher account, wherein a determination is made related to the relevance of each of the engaged accounts of the subset of engaged accounts;
calculating, by at least one processor, a score based on the number of relevant accounts of the set of engaged accounts and the features of the networking service; and
publicizing, by at least one processor, the score to identify the profile account trustworthy following within the networking service.

2. The computer-implemented method of claim 1, further comprising, analyzing, by a least one processor, a growth rate of the audience over a predetermined time.

3. The computer-implemented method of claim 1, wherein the processing of each of the engaged accounts is associated with the account information of each of the engaged accounts.

4. The computer-implemented method of claim 1, further comprising, assessing, by one or more processors, the content generated by the engaged accounts of the subset of accounts.

5. The computer-implemented method of claim 1, wherein the selecting of the subset of engaged accounts is based on the age of the engaged accounts.

6. The computer-implemented method of claim 1, wherein the content generated by the publisher account is selected, by one or more processors, based on the age of the content.

7. The computer-implemented method of claim 1, further comprising, categorizing, by one or more processors, the processed engaged accounts, wherein the categories are relevant and irrelevant engaged accounts.

8. A computer program product for of determining the relevance of an audience, the computer program product comprising:
one or more computer readable storage media and program instructions stored on the one or more computer readable storage media, the program instructions comprising:
program instructions to analyze a publisher account information and content within a networking service, wherein the content is associated with and generated by the publisher account in the networking service, and the publisher account information comprises a set of engaged accounts;
program instructions to select a subset of engaged accounts associated with the publisher account within the networking service, wherein the subset of engaged accounts is associated with the publisher account through various activities within the networking service that are associated with the publisher account's generated content;
program instructions to process each of the engaged accounts of the subset of accounts based on the engaged account's activity related to the content generated by the publisher account, wherein a determination is made related to the relevance of each of the engaged accounts of the subset of engaged accounts; and
program instructions to calculate, a score based on the number of relevant accounts of the set of engaged accounts of the networking service.

9. The computer program product of claim 8, further comprising, program instructions to analyze a growth rate of the set of engaged accounts over a predetermined time.

10. The computer program product of claim 8, wherein the processing of each of the engaged accounts is associated with the account information of each of the engaged accounts.

11. The computer program product of claim 8, further comprising, program instructions to assess the content generated by the engaged accounts of the subset of accounts.

12. The computer program product of claim 8, wherein the selecting of the subset of engaged accounts is based on the age of the engaged accounts.

13. The computer program product of claim 8, further comprising, program instruction to select the content generated by the publisher account based on the age of the content.

14. The computer program product of claim 8, further comprising, program instructions to categorize the processed engaged accounts, wherein the categories are relevant and irrelevant engaged accounts.

15. A computer system for of determining the relevance of an audience, the computer program product comprising:
one or more computer processors, one or more computer readable storage media, and program instructions stored on the one or more computer readable storage media for execution by, at least one of the one or more processors, the program instructions comprising:
program instructions to analyze a publisher account information and content within a networking service, wherein the content is associated with and generated by the publisher account in the networking service, and the publisher account information comprises a set of engaged accounts;
program instructions to select a subset of engaged accounts associated with the publisher account within the networking service, wherein the subset of engaged accounts is associated with the publisher account through various activities within the networking service that are associated with the publisher account's generated content;
program instructions to process each of the engaged accounts of the subset of accounts based on the engaged account's activity related to the content generated by the publisher account, wherein a determination is made related to the relevance of each of the engaged accounts of the subset of engaged accounts; and
program instructions to calculate, a score based on the number of relevant accounts of the set of engaged accounts of the networking service.

16. The computer system of claim 15, further comprising, program instructions to analyze a growth rate of the set of engaged accounts over a predetermined time.

17. The computer system of claim 15, wherein the processing of each of the engaged accounts is associated with the account information of each of the engaged accounts.

18. The computer system of claim 15, further comprising, program instructions to assess the content generated by the engaged accounts of the subset of accounts.

19. The computer system of claim 15, wherein the selecting of the subset of engaged accounts is based on the age of the engaged accounts.

20. The computer system of claim 15, further comprising, program instruction to select the content generated by the publisher account based on the age of the content.
